(19) United States
(12) Patent Application Publication
(10) Pub. No.: US 2011/0142636 A1
(43) Pub. Date: Jun. 16, 2011

(54) EXPANSION ASSEMBLY FOR A ROTOR BLADE OF A WIND TURBINE

(75) Inventor: Gerald Addison Curtin, Niskayuna, NY (US)

(73) Assignee: GENERAL ELECTRIC COMPANY, Schenectady, NY (US)

(21) Appl. No.: 12/911,202

(22) Filed: Oct. 25, 2010

(51) Int. Cl. F03D 11/00; F03D 11/04

(52) U.S. Cl. 416/62; 416/244 R

(57) ABSTRACT

An expansion assembly for a rotor blade of a wind turbine is disclosed. The expansion assembly may generally include a spacer having a first end configured to be attached to a blade root of the rotor blade and a second end configured to be attached to a hub of the wind turbine. Additionally, the expansion assembly may comprise a wing defining a substantially aerodynamic profile and including a base portion configured on the spacer and an outboard portion extending from the spacer in a generally spanwise direction. The outboard portion of the wing may generally be configured to be disposed adjacent to at least one of a suction side and a pressure side of the rotor blade.

### FIELD OF THE INVENTION

The present subject matter relates generally to rotor blades for a wind turbine and, more particularly, to a rotor blade assembly including an expansion assembly for increasing the energy output of a wind turbine.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. For example, it is generally known that the energy output of a wind turbine may be improved by increasing the length and/or the aerodynamic efficiency of the rotor blades. However, to increase the length and/or efficiency of the rotor blades of an existing wind turbine, it is typically necessary for the existing rotor blades to be replaced with new blades. Generally, the complete replacement of the rotor blades of a wind turbine involves significant turbine downtime and is also very expensive due to the high costs of manufacturing, transporting and installing the new blades.

Accordingly, there is need for an expansion assembly that can be attached to a rotor blade of an existing wind turbine so as to provide the rotor blade increased length and improved aerodynamic efficiency.

### BRIEF DESCRIPTION OF THE INVENTION

Aspects and advantages of the invention will be set forth in part in the following description, or may be obvious from the description, or may be learned through practice of the invention.

In one aspect, the present subject matter discloses an expansion assembly for a rotor blade of a wind turbine. The expansion assembly may generally include a spacer having a first end configured to be attached to a blade root of the rotor blade and a second end configured to be attached to a hub of the wind turbine. Additionally, the expansion assembly may comprise a wing defining a substantially aerodynamic profile and including a base portion configured on the spacer and an outboard portion extending from the spacer in a generally spanwise direction. The outboard portion of the wing may generally be configured to be disposed adjacent at least one of a suction side and a pressure side of the rotor blade.

In another aspect, the present subject matter discloses a rotor blade assembly for a wind turbine. The rotor blade assembly may generally include a rotor blade having a blade root and a blade tip disposed opposite the blade root. The rotor blade may also include a suction side and a pressure side extending between a leading edge and a trailing edge. Additionally, the rotor blade assembly may also include an expansion assembly coupled to the rotor blade. The expansion assembly may generally be configured as discussed above and described in greater detail herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine of conventional construction;

FIG. 2 illustrates a suction side view of a rotor blade of conventional construction;

FIG. 3 illustrates a suction side view of one embodiment of a rotor blade assembly including an expansion assembly in accordance with aspects of the present subject matter;

FIG. 4 illustrates a cross-sectional view of the embodiment of the rotor blade assembly illustrated in FIG. 3, particularly illustrating a cross-sectional view of a spacer and a wing of the expansion assembly;

FIG. 5 illustrates another cross-sectional view of the embodiment of the rotor blade assembly illustrated in FIG. 3, particularly illustrating a cross-sectional view of the positioning a portion of a wing of the expansion assembly relative to the rotor blade of the rotor blade assembly;

FIG. 6 illustrates a suction side view of another embodiment of a rotor blade assembly including an expansion assembly in accordance with aspects of the present subject matter;

FIG. 7 illustrates a cross-sectional view of the embodiment of the rotor blade assembly illustrated in FIG. 6, particularly illustrating a cross-sectional view of a spacer and a wing of the expansion assembly; and,

FIG. 8 illustrates another cross-sectional view of the embodiment of the rotor blade assembly illustrated in FIG. 6, particularly illustrating a cross-sectional view the positioning of a portion of a wing of the expansion assembly relative to the rotor blade of the rotor blade assembly.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an expansion assembly for improving the energy output of a wind turbine. In particular, an expansion assembly is disclosed that can be attached to a rotor blade to form a rotor blade assembly having an increased length and improved aerodynamic efficiency. For example, the expansion assembly may include a spacer component configured to increase the effective length of the rotor blade to which the expansion assembly is attached. Additionally, the expansion assembly may include a wing component configured to increase the aerodynamic efficiency of the rotor blade by improving the wind capturing capability of the blade. As such, in several embodiments, the expansion assembly may be configured to be attached to a rotor blade of any existing wind turbine so as to improve the overall performance of the wind turbine. However, it should be appreciated that the expansion assembly of the present subject matter may generally be configured to be attached to any type of rotor blade, regardless of whether the rotor blade is new or pre-existing.

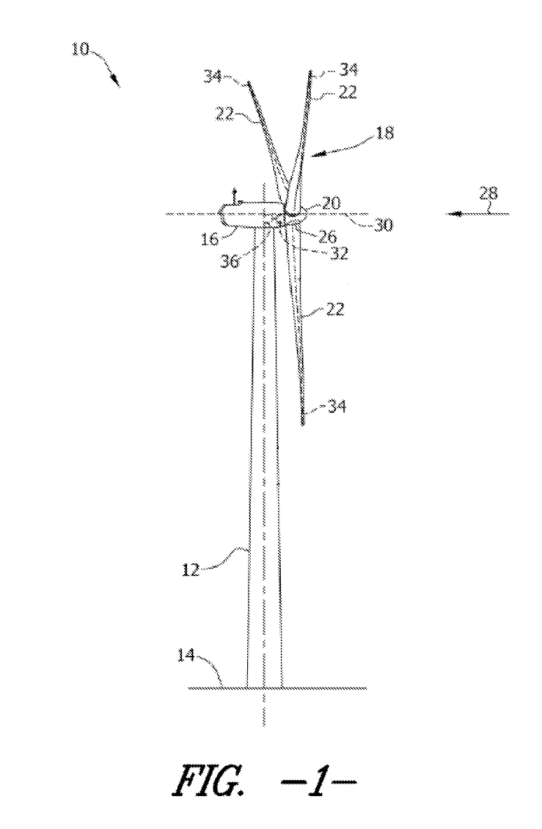

Referring now to the drawings. FIG. 1 illustrates a perspective view of a wind turbine 10 of conventional construction. As shown, the wind turbine 10 is a horizontal-axis wind turbine. However, it should be appreciated that the wind turbine 10 may be a vertical-axis wind turbine. In the illustrated embodiment, the wind turbine 10 includes a tower 12 that extends from a support surface 14, a nacelle 16 mounted on the tower 12, and a rotor 18 that is coupled to the nacelle 16. The rotor 18 includes a rotatable hub 20 and at least one rotor blade 22 coupled to and extending outward from the hub 20. As shown, the rotor 18 includes three rotor blades 22. However, in an alternative embodiment, the rotor 18 may include more or less than three rotor blades 22. Additionally, in the illustrated embodiment, the tower 12 is fabricated from tubular steel to define a cavity (not illustrated) between the support surface 14 and the nacelle 16. In an alternative embodiment, the tower 12 may be any suitable type of tower having any suitable height.

The rotor blades 22 may generally have any suitable length that enables the wind turbine 10 to function as described herein. Additionally, the rotor blades 22 may be spaced about the hub 20 to facilitate rotating the rotor 18 to enable kinetic energy to be transferred from the wind into usable mechanical energy, and subsequently, electrical energy. Specifically, the hub 20 may be rotatably coupled to an electric generator (not illustrated) positioned within the nacelle 16 to permit electrical energy to be produced. Further, the rotor blades 22 may be mated to the hub 20 at a plurality of load transfer regions 26. Thus, any loads induced to the rotor blades 22 are transferred to the hub 20 via the load transfer regions 26.

As shown in the illustrated embodiment, the wind turbine may also include a turbine control system or turbine controller 36 centralized within the nacelle 16. However, it should be appreciated that the controller 36 may be disposed at any location on or in the wind turbine 10, at any location on the support surface 14 or generally at any other location. The controller 36 may generally be configured to control the various operating modes of the wind turbine 10 (e.g., start-up or shut-down sequences). Additionally, the controller 36 may also be configured to control the blade pitch or pitch angle of each of the rotor blades 22 (i.e., an angle that determines a perspective of the rotor blades 22 with respect to the direction 28 of the wind) to control the load and power generated by the wind turbine 10 by adjusting an angular position of at least one rotor blade 22 relative to the wind. For instance, the controller 36 may control the pitch angle of the rotor blades 22, either individually or simultaneously, by transmitting suitable control signals to a pitch drive or pitch adjustment system 32 configured to rotate blades 22 along their longitudinal axes 34.

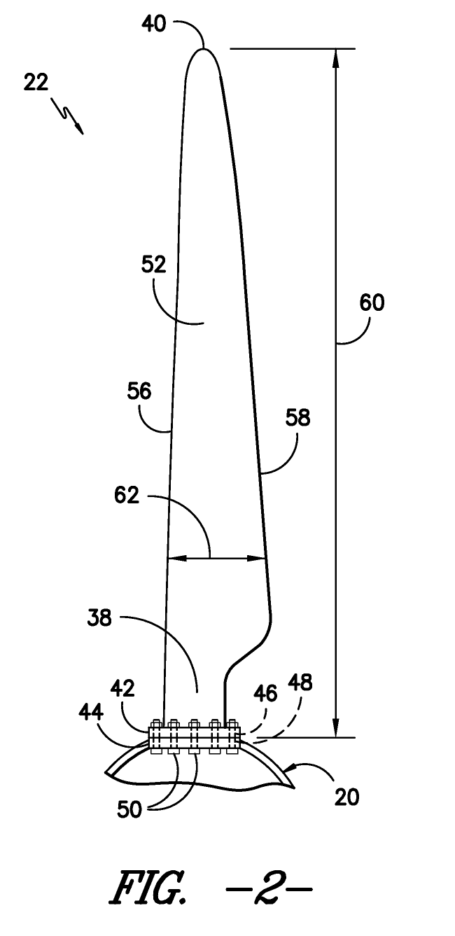

Referring to FIG. 2, there is illustrated a suction side view of one embodiment of a rotor blade 22 of conventional construction. The rotor blade 22 generally includes a blade root 38 and a blade tip 40 disposed opposite the blade root 38. The blade root 38 may generally have a substantially cylindrical shape and may be configured as relatively thick and rigid section of the rotor blade 22 so as to withstand the bending moments and other forces generated on the blade 22 during operation of the wind turbine 10. As indicated above, the blade root 38 may also be configured to be mounted or otherwise attached to the hub 20 of the wind turbine 10. For example, in one embodiment, the blade root 38 may include an outwardly extending blade flange 42 configured to be aligned with and mounted to a corresponding attachment component 44 of the hub 20 (e.g., a pitch bearing or any other suitable load transfer component). In particular, the blade flange 42 may generally define a plurality of bolt holes 46 having a bolt hole pattern corresponding to the pattern of bolt holes 48 defined in the attachment component 44. As such, the rotor blade 22 may be rigidly attached to the hub 20 using a plurality of bolts 50 or any other suitable attachment mechanisms and/or devices. However, it should be appreciated by those of ordinary skill in the art that, in general, the rotor blade 22 may be attached to the hub 20 of the wind turbine 10 using any suitable means and, thus, the blade 22 need not be attached to the hub 20 utilizing the exact configuration and/or components described and illustrated herein.

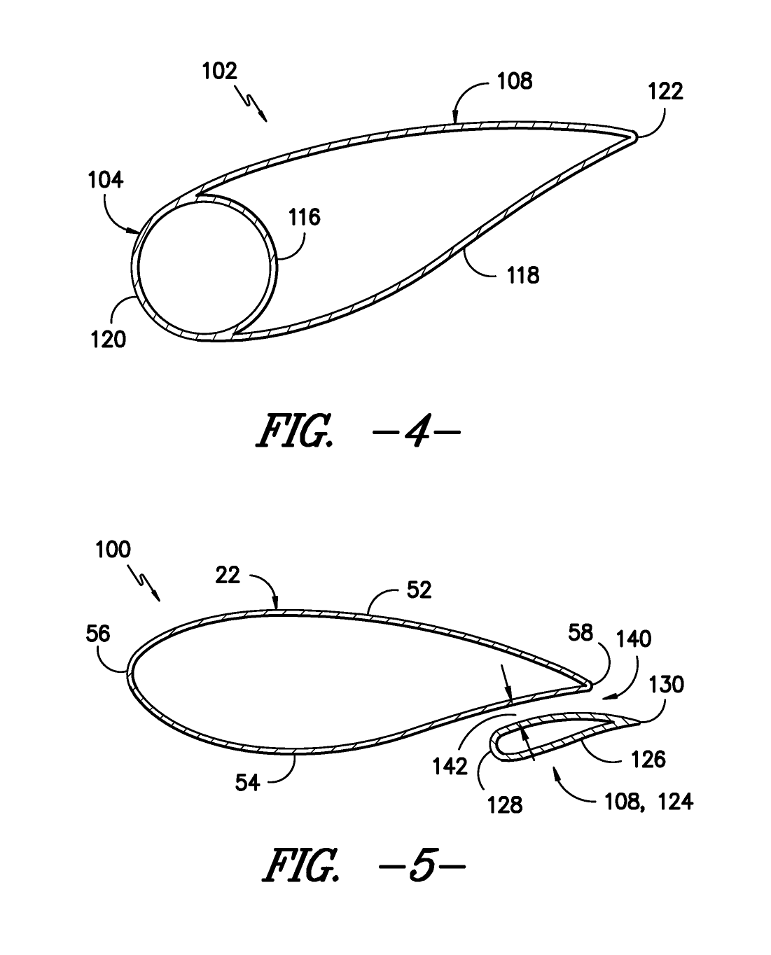

The rotor blade 22 may also include a suction side 52 and a pressure side 54 (FIG. 5) extending between a leading edge 56 and a trailing edge 58. Further, the rotor blade 22 may have a span 60 defining the total length between the blade root 40 and the blade tip 38 and a chord 62 defining the total length between the leading edge 56 and the trailing edge 58. As is generally understood, the chord 62 may generally vary in length with respect to the span 60 as the rotor blade 22 extends from the blade root 38 to the blade tip 40.

The rotor blade 22 may also generally define any suitable aerodynamic profile or shape. In several embodiments, the rotor blade 22 may define an airfoil shaped cross-section. For example, the rotor blade 22 may be configured as a symmetrical airfoil or a cambered airfoil. In addition, the rotor blade 22 may also be aeroelastically tailored. Aeroelastic tailoring of the rotor blade 22 may entail bending of the blade 22 in a generally chordwise direction and/or in a generally spanwise direction. The chordwise direction generally corresponds to a direction parallel to the chord 62 of the rotor blade 22. The spanwise direction generally corresponds to a direction parallel to the span 60 of the rotor blade 22. Aeroelastic tailoring may further entail twisting of the rotor blade 22, such as twisting the blade 22 in a generally chordwise and/or spanwise direction.

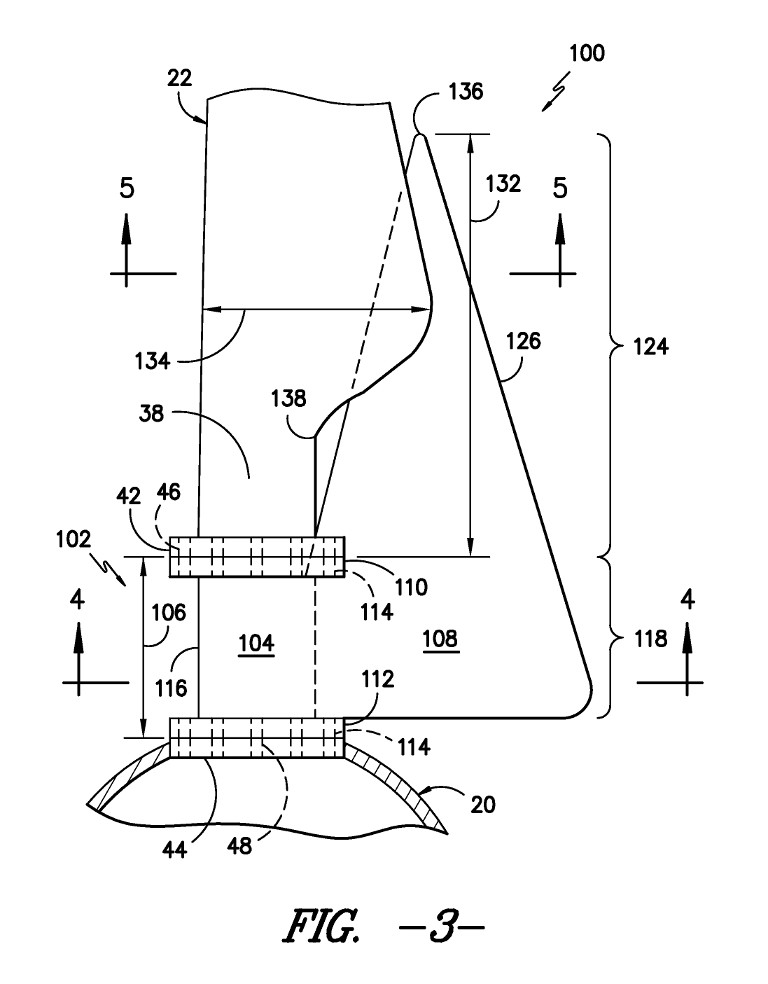

Referring now to FIGS. 3-5, there is illustrated one embodiment of a rotor blade assembly 100 having an expansion assembly 102 for improving the energy output of a wind turbine. In particular, FIG. 3 illustrates a suction side view of one embodiment of the rotor blade assembly 100 including an expansion assembly 102 attached to a rotor blade 22. Additionally, FIGS. 4 and 5 illustrate cross-sectional views of the embodiments of the rotor blade 22 and the expansion assembly 102 shown in FIG. 3. It should be appreciated that the rotor blade 22 of the rotor blade assembly 100 may generally be configured as described above with reference to FIG. 2.

In general, the expansion assembly 102 of the rotor blade assembly 100 may be configured to improve the energy output of a wind turbine 10. For example, in one aspect, the expansion assembly 102 may be configured to expand or extend the overall length of the rotor blade assembly 100 as compared to the original span 60 of the rotor blade 22. Thus, the expansion assembly 102 may include a spacer 104 configured to be attached between the blade root 38 of the rotor blade 22 and the hub 20 of the wind turbine 10. As such, the effective length of the rotor blade 22 may be increased by the height 106 of the spacer 104, thereby increasing the capability of the rotor blade assembly 100 to convert kinetic energy from the wind into usable mechanical energy. Additionally, in another aspect, the expansion assembly 102 may be configured to enhance the efficiency of the rotor blade 22 and, thus, may include a wing 108 extending from the spacer 104 which provides additional blade area for capturing the wind flowing adjacent to the wind turbine 10. As such, the overall aerodynamic efficiency of the rotor blade assembly 100 may be improved, thereby further increasing the capability of the rotor blade assembly 100 to effectively extract energy from the wind.

Referring particularly to FIG. 3, as indicated above, the spacer 104 of the expansion assembly 102 may generally be configured to increase the effective length of the rotor blade 22 of the rotor blade assembly 100. Thus, in one embodiment, the spacer 104 may generally be configured to be attached to the rotor blade 22 at one end and to the hub 20 at the other end using the same or a similar attachment mechanism and/or means as that utilized to secure the blade root 38 to the hub 20. For example, as shown in FIG. 3, the spacer 104 may include a first flange 110 configured to be attached to the blade flange 42 of the rotor blade 22 and a second flange 112 configured to be attached to the attachment component 44 of the hub 20. In particular, the first and second flanges 110, 112 may each define a plurality of bolt holes 114 arranged in a pattern corresponding to the bolt hole patterns of the bolt holes 46, 48 defined in the blade flange 42 and the attachment component 44, respectively. As such, the spacer 104 may be configured to be rigidly attached between the rotor blade 22 and the hub 20 using a plurality of bolts 50 (FIG. 2) or any other suitable attachment mechanism and/or device. It should be appreciated that, in embodiments in which the rotor blade 22 of the present subject matter is configured to be attached to the hub 20 using a different attachment configuration and/or a different attachment means, the spacer 104 may generally include features corresponding to such differing attachment configuration/means to permit the spacer 104 to be secured between the rotor blade 22 and the hub 20. It should also be appreciated that, since the spacer 104 of the expansion assembly 102 is attached between the rotor blade 22 and the hub 20, the orientation of the spacer 104 may be configured to be adjusted by the pitch adjustment system 32 (FIG. 1) as the pitch angle of the rotor blade 22 is being adjusted.

In general, the spacer 104 may define any suitable length106 between the rotor blade 22 and the hub 20 so as to provide an increase in the effective length of the rotor blade assembly 100. For example, in a particular embodiment of the present subject matter, the length 106 of the spacer 104 may range from about 0% of the span 60 of the rotor blade 22 to about 20% of the span 60 of the rotor blade 22, such from about 0% to about 15% of the span 60 or from about 5% to about 10% of the span 60 and all other subranges therebetween. However, in alternative embodiments, the length106 of the spacer 105 may be greater than about 20% of the span 60 of the rotor blade 22.

Additionally, in order to serve as an extension of the rotor blade 22, it should be appreciated that, in one embodiment, the spacer may generally include a spacer body 116 having a substantially similar shape and/or configuration as the blade root 38 of the rotor blade 22. For example, the spacer body 116 may generally define a substantially cylindrical shaped segment of the spacer 104 extending between the first and second flanges 110, 112. Additionally, similar to the blade root 38, the spacer body 116 may be configured as a relatively thick and rigid member so as to be capable of withstanding the bending moments and other forces generated during operation of the wind turbine 10.

Referring still to FIGS. 3-5, the wing 108 of the expansion assembly 102 may generally serve to expand or increase the effective blade area of the rotor blade assembly 100. Thus, the wing may generally comprise any suitably shaped member which extends outwardly from the spacer 104 and is configured to improve the overall efficiency of the rotor blade assembly 100 by increasing its the wind capturing capability. For example, in several embodiments, the wing 108 may generally be configured so as to define a substantially aerodynamic profile, such as by being configured as a symmetrical airfoil or a cambered airfoil. Additionally, one or more portions of the wing 108 may be aeroelastically tailored to further increase the aerodynamic efficiency of the rotor blade assembly 100, such as by bending and/or twisting a portion(s) the wing 108 in a generally chordwise and/or spanwise direction.

Referring particularly to FIGS. 3 and 4, in one embodiment, the wing108 of the expansion assembly 102 may generally comprise a base portion 118 configured on the spacer 104. In particular, the base portion 118 of the wing 108 may generally comprise the section of the wing 108 extending outwardly from the spacer 104 in a direction substantially perpendicular to the spanwise direction (e.g., in the chordwise direction). Additionally, in several embodiments, the base portion 118 of the wing 108 may generally be configured to be formed integrally with the spacer 104. For example, as shown in FIG. 4, the base portion 118 may be formed as an integral extension of the spacer 104 and may extend outwardly therefrom. As such, the base portion 118 and the spacer 104 of the expansion assembly 102 may generally define a substantially aerodynamic, airfoil shaped cross-section having a leading edge 120 defined by a portion of the spacer 104 and a trailing edge 122 defined by the base portion 118. Accordingly, the kinetic energy of the air flowing over the expansion assembly 102 in the area generally adjacent to the spacer 104 may be effectively captured by the expansion assembly 102 for conversion to mechanical energy.

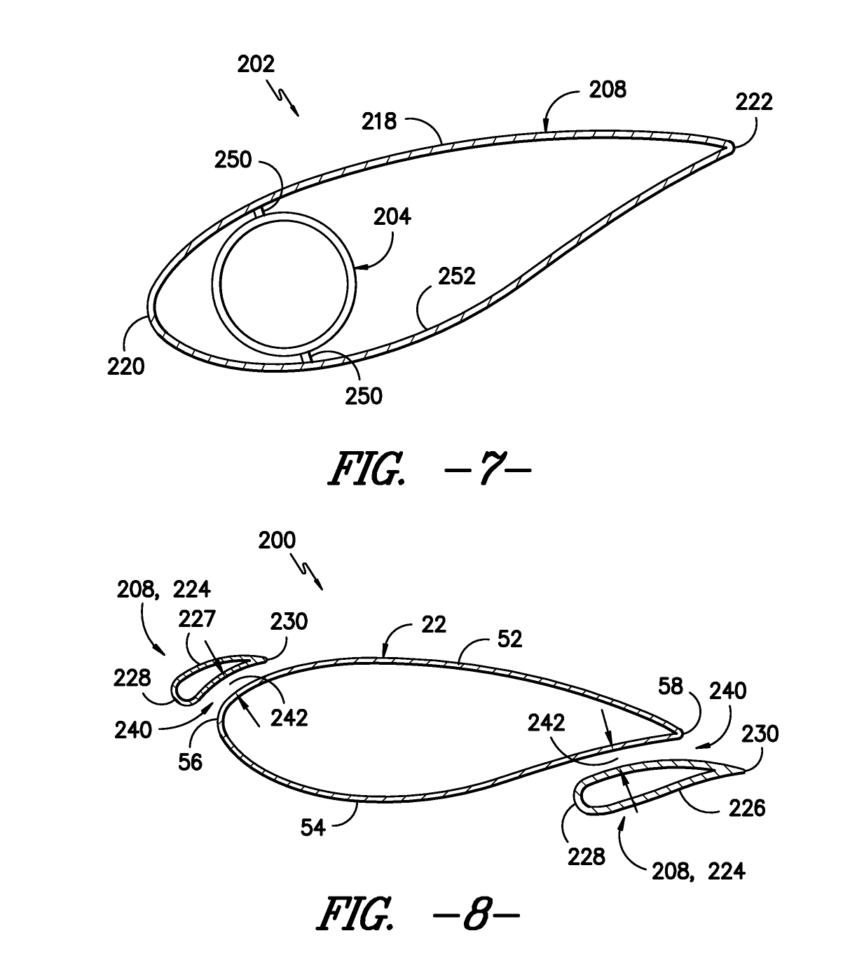

It should be appreciated that, although the base portion 118 of the wing 108 is shown as being formed integrally with the spacer body 116 of the spacer 104, the base portion 118 may generally be formed integrally with any component and/or feature of the spacer 104. For example, in an alternative embodiment, the base portion 118 may be formed integrally with the first and second flanges 110, 112 and extend outwardly therefrom. Additionally, it should be appreciated that, in several embodiments of the present subject matter, the base portion 118 of the wing 108 need not be formed integrally with the spacer 104. For instance, as will be described below with reference to FIG. 7, the wing 108 may be manufactured as a separate component which is be configured to be separately attached to the spacer 104 in order to form the disclosed expansion assembly 102.

Referring particularly to FIGS. 3 and 5, the wing 108 of the expansion assembly 102 may also include an outboard portion 124 configured to extend adjacent the rotor blade 22. In general, the outboard portion 124 may comprise a blade or airfoil segment 126 having a substantially aerodynamic profile. For example, as shown in FIG. 5, the airfoil segment 126 may include a leading edge 128 and a trailing edge 130. Additionally, the outboard portion 124 may be configured to extend away from the spacer 104 in a generally spanwise direction such that the airfoil segment 126 is disposed on the suction side 52 and/or the pressure side 54 of the rotor blade 22. As such, the outboard portion 124 of wing 108 may generally serve as an auxiliary or secondary airfoil for the rotor blade 22 so as to provide a multi-element airfoil effect along the suction side 52 and/or pressure side 54 of the blade 22.

For example, as shown in FIG. 5, the airfoil segment 126 of the outboard portion 124 may generally be disposed adjacent the pressure side 54 of the rotor blade 22 substantially adjacent to the trailing edge 58. However, it should be appreciated that, in general, the airfoil segment 126 may be configured to be disposed at any suitable location along the outer perimeter of the rotor blade 22. For example, the airfoil segment 126 may be disposed at any suitable chordwise location along the pressure side 54 or suction side 52 the rotor blade 22. Alternatively, the airfoil segment 126 may be configured to be generally aligned with the leading edge 56 or the trailing edge 58 of the rotor blade 22.

It should be appreciated that the outboard portion 124 of the wing 108 may generally define any suitable spanwise length132. For example, as shown in FIG. 3, the outboard portion 124 may define a spanwise length 132 which is greater than the distance defined between the blade root 38 and the maximum chord location 134 of the rotor blade 22. Alternatively, the outboard portion 124 may define a spanwise length132 which is less than or equal to the distance defined between the blade root 38 and the maximum chord location 134. For instance, in one embodiment, the outboard portion 124 of the wing 108 may be configured to be disposed along the rotor blade 22 to the extent that a tip 136 of the outboard portion 124 is disposed at a location between the maximum chord location 134 and the point 138 at which the blade 22 begins to transition from the cylindrical blade root 38 to a substantially aerodynamic cross-section.

Additionally, as shown in FIG. 5, the airfoil segment 126 of the outboard portion 124 may generally be disposed relative to the rotor blade 22 such that a gap 140 is defined between the airfoil segment 126 and the rotor blade 22. As such, some of the air flowing over the rotor blade 22 may be channeled between the wing 108 and the rotor blade 22, thereby reducing flow separation of the air from the rotor blade 22 and also increasing the amount of lift generated by the rotor blade 22. In general, it should be appreciated that the gap 140 defined between the outboard portion and the rotor blade may have any suitable height 142 that permits the airfoil segment 126 as described herein.

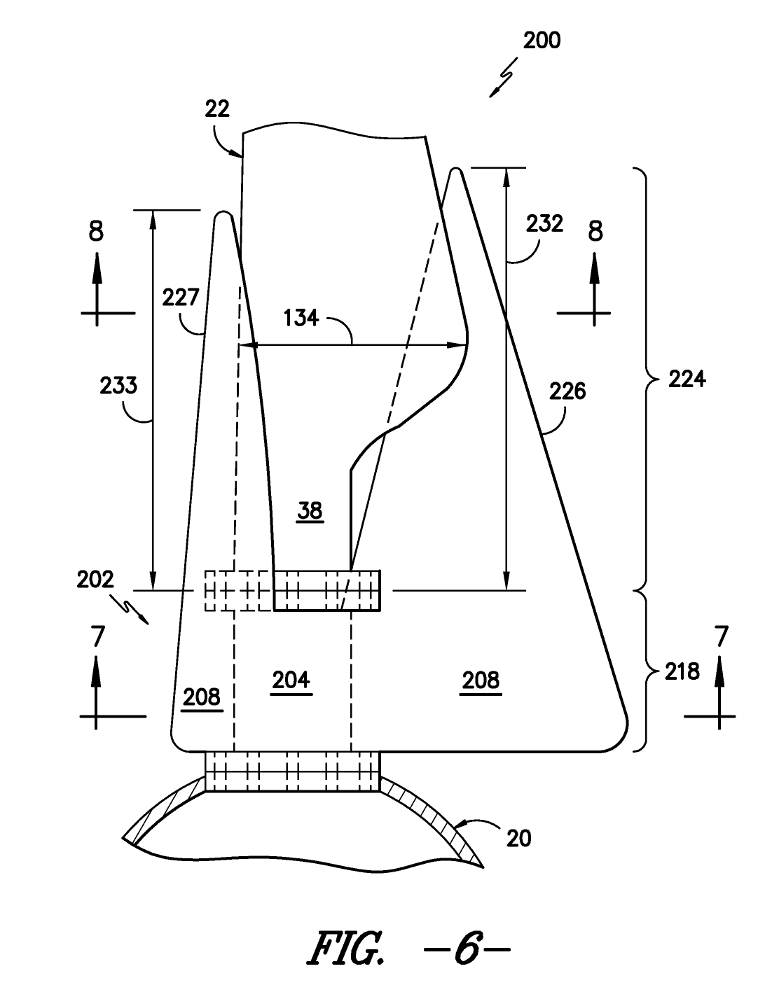

Referring now to FIGS. 6-8, there is illustrated another embodiment of a rotor blade assembly 200 having an expansion assembly 202 for improving the energy output of a wind turbine. In particular, FIG. 6 illustrates a suction side view of the embodiment of the rotor blade assembly 200 including an expansion assembly 202 attached to a rotor blade 22. Additionally, FIGS. 7 and 8 illustrate cross-sectional views of the embodiments of the rotor blade 22 and the expansion assembly 202 shown in FIG. 3.

In general, the illustrated rotor blade assembly 200 may be configured similarly to rotor blade assembly 100 described above with reference to FIGS. 3-5. Thus, the rotor blade assembly 200 may include an expansion assembly 202 having a spacer 204 configured to increase the effective length of the rotor blade 22 of the rotor blade assembly 200. Thus, the spacer 204 may be configured to be attached between the blade root 38 of the rotor blade 22 and the hub 20 of the wind turbine 10 so to serve as an extension of the rotor blade 22. The expansion assembly 202 may also include a wing 208 configured to improve the overall aerodynamic efficiency of the rotor blade assembly 200. Thus, the wing 208 may include an aerodynamically shaped base portion 218 having a leading edge 220 and trailing edge 222 and extending outwardly from the spacer 204 in a direction substantially perpendicular to the spanwise direction (e.g., in the chordwise direction). Additionally, the wing 208 may include an outboard portion 224 configured to extend away from the spacer 208 in a generally spanwise direction such that the outboard portion 224 is disposed on the suction side 52 and/or the pressure side 54 of the rotor blade 22.

However, in the embodiment illustrated in FIGS. 6-8, the wing 208 of the expansion assembly 202 may generally be formed as a separate component from the spacer 204 and, thus, may be configured to be attached and/or coupled to spacer 204. For example, as shown in FIG. 7, the base portion 218 of the wing 208 may be configured to be rigidly coupled to the spacer using a plurality of support members 250 extending between the spacer 204 and an inner surface 252 of the base portion 218. However, it should be appreciated that, in general, the wing 208 may generally be configured to be coupled or otherwise attached to the spacer 204 using any suitable means, such as by using mechanical fasteners (e.g., screws, bolts, clips, brackets and the like) adhesives, tape and/or any other suitable attachment mechanism and/or means.

It should also be appreciated that, in an alternative embodiment of the present subject matter, the wing 208 of the expansion assembly 202 may be configured to be rotatably attached to spacer 204 such that the orientation and/or position of the wing 208 relative to the spacer 204 and/or the rotor blade 22 may be adjusted independent of any pitch adjustments made using the pitch adjustment system 32 (FIG. 1) of the wind turbine 10. For instance, in the base portion 218 of the wing 208 may be rotatably attached to the spacer 204 using one or more bearings, bushings or any other suitable rotational attachment mechanisms and/or means. Additionally, a separate pitch control mechanism (not shown) may be disposed within the expansion assembly 202 so as to independently adjust the position and/or orientation of the wing 208 relative to the spacer 204 and/or the rotor blade 22.

Additionally, referring particularly to FIGS. 6 and 8, the outboard portion 224 of the wing 208 may generally comprise a plurality of airfoil segments 226, 227 defining substantially aerodynamic profiles. For example, the outboard portion 224 may comprise a first airfoil segment 226 and a second airfoil segment 227, with each airfoil segment 226, 227 including respective leading and trailing edges 228, 230. As such, the airfoil segments 226, 227 may generally serve as auxiliary or secondary airfoils for the rotor blade 22 by providing a multi-element airfoil effect along the suction side and/or pressure side of the rotor blade 22. It should be appreciated by those of ordinary skill in the art that the outboard portion 224 need not include only first and second airfoil segments 226, 227 but may generally comprise any number of airfoil segments extending in the spanwise direction along the rotor blade 22.

As shown in the illustrated embodiment, the first airfoil segment 226 may be disposed on the pressure side 54 of the rotor blade 22 substantially adjacent to the trailing edge 58. Additionally, the second airfoil segment 227 may be disposed on the suction side 52 of the rotor blade 22 generally adjacent to the leading edge 56. However, it should be appreciated that, in general, the outboard portion 224 of the wing 208 may generally be configured such that the first and second airfoil segments 226, 227 are arranged at any suitable location along the outer perimeter of the rotor blade 22. For example, the first and second airfoil segments 226, 227 may be disposed at any chordwise location along the pressure side 54 and/or the suction side 52 of the rotor blade 22, respectively. Alternatively, the outboard portion 224 may be configured such that both the first and second airfoil segments 226, 227 are disposed on the same side of the rotor blade 22. Additionally, one or both of the first and second airfoil segments 126, 127 may be configured to be generally aligned with the leading edge 56 and/or the trailing edge 58 of the rotor blade 22.

Additionally, the first airfoil segment 226 may generally define a first spanwise length 232 and the second airfoil segment 227 may generally define a second spanwise length 233. In various embodiments, the first spanwise length 232 may be equal to or differ from the second spanwise length 233. Further, it should be appreciated that the spanwise lengths 232, 233 may generally be chosen such that the airfoil segments 226, 227 extend any suitable distance in the spanwise direction along the rotor blade 22. For example, in one embodiment, one or both of the airfoil segments 226, 227 may define a spanwise length 232, 233 which is greater than the distance defined between the blade root 38 and the maximum chord location 134 of the rotor blade 22. Alternatively, one or both of the airfoil segments 226, 227 may define a spanwise length 232, 233 which is less than or equal to the distance defined between the blade root 38 and the maximum chord location 134.

Additionally, as shown in FIG. 8, the first and second airfoil segments 226, 227 of the outboard portion 224 may generally be disposed relative to the rotor blade 22 such that a gap 240 is defined between each airfoil segment 226, 227 and the rotor blade 22. As such, some of the air flowing over the rotor blade 22 may be channeled between the airfoil segments 226, 227 and the rotor blade 22, thereby reducing flow separation of the air from the rotor blade 22 and also increasing the amount of lift generated by the rotor blade 22. In general, it should be appreciated that the gaps 242 defined between the airfoil segments 226, 227 and the rotor blade 22 may have any suitable height 242 that permits the airfoil segments 226, 227 to function as described herein.

Further, it should be appreciated that the expansion assembly 102, 202 of the present subject matter may generally be formed from any suitable material. However, in a particular embodiment, the expansion assembly 102, 202 may be formed from a relatively lightweight material, such as a composite material (e.g., a carbon laminate and/or a glass laminate), a lightweight metal or any other suitable lightweight material. Additionally, it should be appreciated that the various components of the expansion assembly 102, 202 may be formed from the same material or from differing materials. For instance, in one embodiment, the spacer 104, 204 may be formed from a lightweight metal while the wing 108, 208 may be formed from a composite material and vice versa.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An expansion assembly for a rotor blade of a wind turbine, the expansion assembly comprising:
a spacer having a first end configured to be attached to a blade root of the rotor blade and a second end configured to be attached to a hub of the wind turbine; and,
a wing defining a substantially aerodynamic profile and including a base portion configured on the spacer and an outboard portion extending from the spacer in a generally spanwise direction,
wherein the outboard portion of the wing is configured to be disposed adjacent to least one of a suction side and a pressure side of the rotor blade.

2. The expansion assembly of claim 1, wherein the first end of the spacer comprises a first flange configured to be attached to a blade flange of the blade root and the second end of the spacer comprises a second flange configured to be attached to a component of the hub.

3. The expansion assembly of claim 1, wherein the spacer has a length of about 0% to about 20% of the span of the rotor blade.

4. The expansion assembly of claim 1, wherein the base portion of the wing is formed integrally with the spacer.

5. The expansion assembly of claim 1, wherein the wing is formed as a separate component from the spacer, the base portion of the wing being configured to be attached to the spacer.

6. The expansion assembly of claim 5, wherein the base portion of the wing is configured to be rotatably attached to the spacer.

7. The expansion assembly of claim 1, wherein the outboard portion of the wing comprises an airfoil segment configured to be disposed adjacent the suction side of the rotor blade.

8. The expansion assembly of claim 1, wherein the outboard portion of the wing comprises an airfoil segment configured to be disposed adjacent the pressure side of the rotor blade.

9. The expansion assembly of claim 1, wherein the outboard portion of the wing comprises a first airfoil segment configured to be disposed adjacent the suction side of the rotor blade and a second airfoil segment configured to be disposed adjacent the pressure side of the rotor blade.

10. The expansion assembly of claim 1, wherein the outboard portion of the wing is configured to be disposed relative to the rotor blade such that a gap is defined between the outboard portion and the rotor blade.

11. The expansion assembly of claim 1, wherein a spanwise length of the outboard portion of the wing is equal to less than a distance between the blade root and a maximum chord location of the rotor blade.

12. A rotor blade assembly for a wind turbine, the rotor blade assembly comprising:
a rotor blade, the rotor blade including a blade root and a blade tip disposed opposite the blade root, the rotor blade further including a suction side and a pressure side extending between a leading edge and a trailing edge; and,
an expansion assembly coupled to the rotor blade, the expansion assembly comprising:
a spacer having a first end configured to be attached to the blade root and a second end configured to be attached to a hub of the wind turbine; and,
a wing defining a substantially aerodynamic profile and including a base portion configured on the spacer and an outboard portion extending from the spacer in a generally spanwise direction,
wherein the outboard portion of the wing is configured to be disposed adjacent at least one of the suction side and the pressure side of the rotor blade.

13. The rotor blade assembly of claim 12, wherein the first end of the spacer comprises a first flange configured to be attached to a blade flange of the blade root and the second end of the spacer comprises a second flange configured to be attached to a component of the hub.

14. The rotor blade assembly of claim 12, wherein the spacer has a length of about 0% to about 20% of the span of the rotor blade.

15. The rotor blade assembly of claim 12, wherein the base portion of the wing is formed integrally with the spacer.

16. The rotor blade assembly of claim 12, wherein the wing is formed as a separate component from the spacer, the base portion of the wing being configured to be attached to the spacer.

17. The rotor blade assembly of claim 16, wherein the base portion of the wing is configured to be rotatably attached to the spacer.

18. The rotor blade assembly of claim 12, wherein the outboard portion of the wing comprises a first airfoil segment configured to be disposed adjacent the suction side of the rotor blade and a second airfoil segment configured to be disposed adjacent the pressure side of the rotor blade.

19. The rotor blade assembly of claim 12, wherein the outboard portion of the wing is configured to be disposed relative to the rotor blade such that a gap is defined between the outboard portion and the rotor blade.

20. The rotor blade assembly of claim 12, wherein a spanwise length of the outboard portion of the wing is equal to less than a distance between the blade root and a maximum chord location of the rotor blade.
